(19) United States
(12) Patent Application Publication
(10) Pub. No.: US 2007/0134974 A1
(43) Pub. Date: Jun. 14, 2007

(54) HOUSING FOR A MEDICAL IMPLANT

(76) Inventors: Marcel Starke, Berlin (DE); Jan Litzke, Berlin (DE)

Correspondence Address: DALINA LAW GROUP, P.C., 7910 IVANHOE AVE. #325, LA JOLLA, CA, 92037, US

(21) Appl. No.: 11/567,822

(22) Filed: Dec. 7, 2006

(30) Foreign Application Priority Data
Dec. 8, 2005 (DE) 10 2005 058 551.5
Jan. 24, 2006 (DE) 10 2006 003 223.3

(51) Int. Cl. H01R 12/24

(52) U.S. Cl. 439/493

(57) ABSTRACT

A housing for a medical implant, such as a cardiac pacemaker, defibrillator, cardioverter, or the like, the housing having a hollow housing and a terminal housing attached to the hollow housing, which has at least one electrical terminal, which is situated in an externally accessible cavity of the terminal housing, for connecting an electrode line. The terminal housing is glued to the hollow housing using an adhesive, the plastic of the terminal housing containing polyurethane and/or polycarbonate and the adhesive being an epoxide or polyurethane.

This application takes priority from German Patent Application DE 10 2005 058 551.5 filed 8 Dec. 2005 and German Patent Application DE 10 2006 003 223.3 filed 24 Jan. 2006, the specifications of which are both hereby incorporated herein by reference.

### BACKGROUND OF THE INVENTION

1. Field of the Invention

The present invention relates to a housing for a medical implant such as an implantable cardiac pacemaker, defibrillator, cardioverter, or the like.

2. Description of the Related Art

A housing for a medical implant comprises a hollow housing, which is used for receiving control electronics, capacitors, and batteries, for example. In addition, the housing comprises a terminal body, which is attached to the hollow housing and has at least one, but typically two to four electrical terminals situated in one or more externally accessible cavities of the terminal body, which are used for connecting one or more electrode lines. Such a terminal body is also referred to as a header. The hollow housing and header together result in a hermetically sealed housing which has the cited electrical components in the interior of the hollow housing, which are connected via supply lines to the electrical terminal or the electrical terminals in the header.

The hollow housing is typically manufactured from biocompatible metal. The electrical connection of the electrical components in the hollow housing to the electrical supply lines located in the header to the electrical terminals typically occurs via bushings which are introduced into a wall of the hollow housing and which terminate the hollow housing with a hermetic seal and, in addition, may also be implemented as filter bushings, which have an electrical low-pass effect.

The terminal housing (also called a header) typically comprises transparent, insulating plastic. The electrical terminals are implemented as sockets, which may receive corresponding plugs of electrode lines. Because of the transparency of the terminal housing, whether an electrode line plug is inserted far enough into the socket of a particular electrical terminal is visible from the outside. The terminal housing may comprise a base body and/or a terminal body, which are connected to one another in a suitable way. Any other construction known from the prior art is also possible, in particular a multipart construction, in which the included components are individually assembled. Therefore, in the following only a terminal housing will be referred to.

High requirements are placed on the quality of a housing for a medical implant. In particular, the hollow housing and terminal housing must work together reliably and tightly over years. The terminal housing itself must be stable and precisely fitted over a long time.

Various approaches are known from the prior art for meeting the above-mentioned requirements. Firstly, casting the terminal housing directly on the hollow housing is known. For this purpose, the hollow housing having supply lines attached thereto for the electrical terminals and contact sockets for the electrode line plugs is inserted into a casting mold and a base body is cast around it by filling the closed casting mold with liquid plastic. The liquid plastic is permitted to cure in the casting mold and results—after removal of the casting mold—in a terminal housing produced in one work step and permanently connected directly to the hollow housing.

Alternatively, pre-mounted terminal housings are known, in which the electrical components, such as electrical contact sockets or electrical supply lines, are first inserted in prefinished injection molded parts made of plastic. Such multipart, pre-mountable terminal housings are known, for example, from WO 01/99239, EP 0 429 024, U.S. Pat. No. 5,282,841, or 6,205,358.

### BRIEF SUMMARY OF THE INVENTION

The object of the present invention is to provide a housing for an electromedical implant such as a cardiac pacemaker or the like, which allows the simplest possible cost-effective production which is not susceptible to error and results in a housing having the required properties.

This object is achieved according to the present invention by a housing of the type cited at the beginning, the plastic for the terminal housing containing polyurethane and/or polycarbonate or at least essential parts thereof comprising polyurethane and/or polycarbonate and the adhesive being quick-curing. The terminal housing is preferably transparent and allows a view from the outside of the electrical terminal.

The adhesive may preferably be processed further during a time of 1 to 15 minutes, especially preferably 5 to 10 minutes.

The adhesive preferably cures at temperatures from approximately 20° to approximately 85° C.

Polyurethane, preferably aromatic and/or aliphatic acrylate polyester polyurethane, or epoxide resin have been shown to be especially preferred materials for the terminal housing. These materials fulfill the desired requirements for long-term stability, transparency, and dimensional stability and also may be glued especially well using epoxide and/or polyurethane.

The advantage of epoxide—particularly comprising epoxide resin—as an adhesive is provided by favorable processing properties of the epoxide and, in addition, by the high strength of the adhesive bond achievable using epoxide and by the biocompatibility of epoxide. In regard to the achievable strength of the adhesive bond, it is especially advantageous that epoxide both adheres very well to various surfaces i.e., allows large adhesion forces, and also has good internal tensile strength itself, i.e., develops large cohesion forces.

The quick-curing adhesive is preferably curable by an external application of energy. The curing of the quick-curing adhesive is triggered and caused by irradiation using electromagnetic radiation—preferably in the lightwave range. Adhesives which cure upon irradiation in the UV wavelength range are known.

In this context, it is advantageous if the terminal housing comprises a material which has a transmission which is sufficiently high in the wavelength range in which the illumination required for curing the quick-curing adhesive lies to allow curing of the quick-curing adhesive at a given illumination intensity in at most four times the duration specified for this illumination intensity. It is thus ensured that the adhesive cures reliably in a sufficiently short time over the entire area of the adhesive bond between hollow housing and terminal housing.

In a further embodiment, the curing of the quick-curing adhesive is merely activated by external energy action and the curing then proceeds without this energy action

Spacer means may advantageously be added to the adhesive to exploit the capillary effect through an optimum adhesive gap, which causes adequate wetting over as much of the surface is possible between the diametrically opposite faces of the terminal housing and the hollow housing. These spacer means are implemented as essentially spherical and preferably have a diameter of 0.1 mm to 0.5 mm.

Instead of epoxide, in principle another adhesive which cures under external energy action may be used for gluing the hollow housing to the terminal body. However, epoxide and/or polyurethane are especially preferred because of their properties.

To ensure reliable and precisely fitted mounting of the prefinished terminal housing on the hollow housing, the terminal housing preferably has two cavities on its side facing toward the hollow housing, which receive anchors attached to the hollow housing in the form of pins projecting from the hollow housing and which, together with the cavities, cause precise positioning of the terminal housing, particularly also during the gluing of the terminal housing to the hollow housing, and improve the transmission of bending forces between hollow and terminal housings.

In regard to shape and volume, the housing is preferably a housing for a cardiac pacemaker, a cardioverter/defibrillator, or a combination of both. In this meaning, a cardiac pacemaker or cardioverter/defibrillator having a housing claimed here is also claimed.

### BRIEF DESCRIPTION OF THE DRAWINGS

The present invention will now be explained in greater detail on the basis of an exemplary embodiment with reference to the figures. In the figures:

FIG. 1 shows a housing of a cardiac pacemaker having a hollow housing made of biocompatible metal and having a terminal housing for connecting electrode lines.

FIG. 2 shows the housing from FIG. 1.

FIG. 3 shows a housing from FIG. 1 having an illustration of the terminal housing with a view of the side facing toward the housing.

FIG. 4 shows a housing from FIG. 1 having wiring elements in a semitransparent illustration.

### DETAILED DESCRIPTION

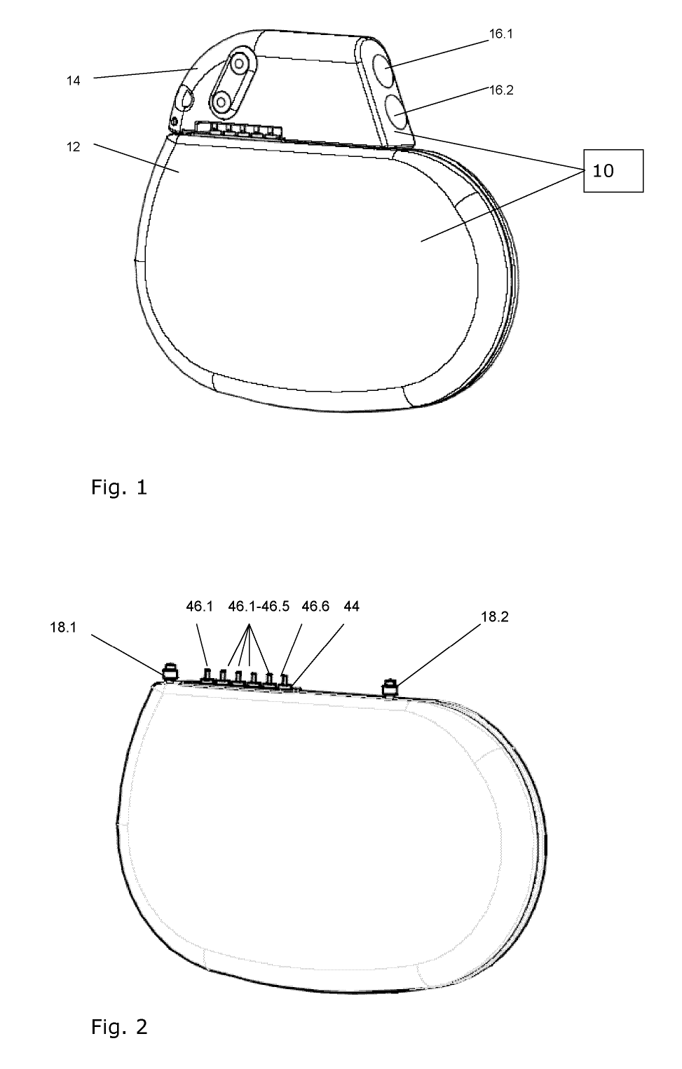

FIG. 1 shows a cardiac pacemaker having a housing 10, which has a hollow housing 12 for receiving batteries, capacitors, and control electronics, as well as a terminal housing 14—also referred to as a header—which comprises two plug sockets 16.1 and 16.2, into which plugs of electrode lines are to be plugged.

According to the present invention, the terminal housing 14 is glued to the hollow housing 12. An adhesive layer made of epoxide or polyurethane is provided for this purpose, which is not recognizable in FIG. 1 and is located between the diametrically opposite faces of the terminal housing 14 and the hollow housing 12.

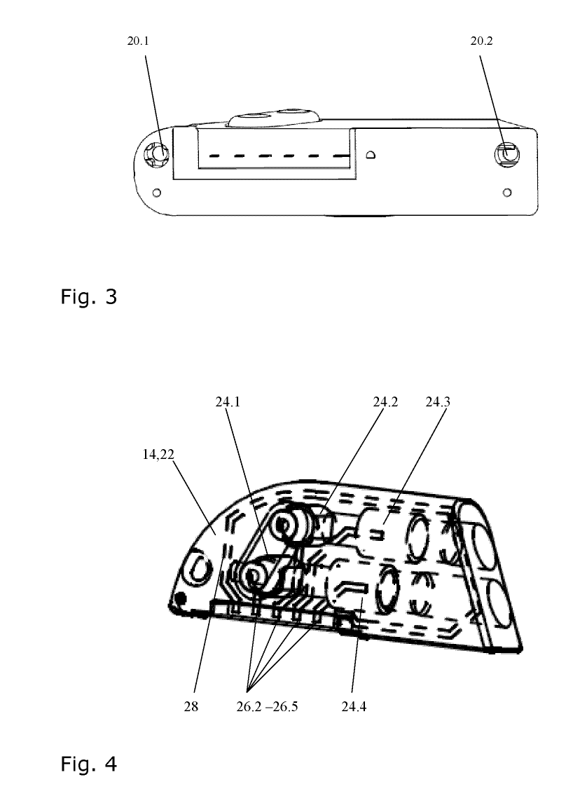

To make the gluing of terminal housing 14 and hollow housing 12 easier, two anchors 18.1 and 18.2 are provided on the hollow housing 12 (see FIG. 2), which engage in corresponding cavities 20.1 and 20.2 of the terminal housing 14 recognizable in FIG. 3.

As may be seen from FIG. 4, the transparent terminal housing 14 contains contact sockets 24.1 through 24.4 situated therein, which partially enclose the plug sockets 16.1 and 16.2, as well as electrical supply lines 26 and an antenna 28. In addition, clamping screws for fixing the electrodes are situated in the terminal housing 14, which are sealed using seals. An x-ray marker is situated in a further cavity of the terminal body 14.

The hollow housing contains a bushing 44, using which electrical terminals are led from the interior of the hollow housing 12 to six electrical contact pins 46.1 through 46.6, which are situated in a row. The contact pins 46.1 and 46.6 are used for contacting the antenna 28, while the contact pins 46.2 through 46.5 are used for contacting the electrical supply lines 26.1 through 26.4, which lead to the contact sockets 24.1 through 24.4.

The contact pins 46.1 through 46.6 are connected by welding to the electrical supply lines 26.1 through 26.4 and to the antenna 28 after the terminal housing 14 is placed on the hollow housing 12. For this purpose, an initially open cavity 46 is provided on the side of the terminal housing 14 facing toward the hollow housing 12, which is encapsulated after the welding of the contact pins 46.1 through 46.6 to the supply lines 26.1 through 26.4 and the antenna 28.

For better identification of the housing 10 thus resulting, an individual x-ray marker may be inserted in the cavity. The antenna 28 and the electrical supply lines 26.1 and 26.4 are welded to the contact pins 46.1 through 46.6. After electrode lines are connected to the housing 10 by inserting corresponding electrode line plugs into the plug sockets 16.1 and 16.2 of the terminal housing 14, the electrode line plugs may be fixed with the aid of seals and clamping screws.

A suitable material for the terminal housing 14 is transparent polyurethane, which may be cast easily and has the desired mechanical and electrical as well as optical properties, specifically, it is transparent. An especially suitable polyurethane is an aromatic acrylic polyester polyurethane. Furthermore, epoxide resin may also be used.

As already noted, a suitable adhesive for gluing the terminal body 14 to the hollow housing 12 is epoxide or also polyurethane. A light-curing epoxide, which is activated and cures upon illumination and/or irradiation with ultraviolet radiation, is especially preferred.

What is claimed is:

1. A housing for a medical implant, such as a cardiac pacemaker, cardioverter/defibrillator, or a combination of a cardiac pacemaker and cardioverter/defibrillator comprising:
a housing;
said housing comprising a hollow housing and a terminal housing attached to said hollow housing;
said terminal housing comprising at least one electrical terminal which is situated in an externally accessible cavity of said terminal housing and configured to connect an electrode line wherein said terminal housing is configured from plastic;
said terminal housing coupled with said hollow housing with an adhesive;
wherein said plastic of said terminal housing contains polyurethane and/or polycarbonate or epoxide resin and wherein said adhesive is quick-curing.

2. The housing according to claim 1 wherein said quick-curing adhesive may be processed further for up to 15 minutes.

3. The housing according to claim 1 wherein said quick-curing adhesive is an epoxide or polyurethane.

4. The housing according to one claim 1 wherein said terminal housing is multipart and wherein parts selected from said terminal housing are coupled together using an adhesive.

5. The housing according to claim 1 wherein said terminal housing is transparent and allows a view of said at least one electrical terminal from outside of said terminal housing.

6. The housing according to claim 5 wherein said transparent plastic of said terminal housing contains polyurethane.

7. The housing according to claim 1 wherein said adhesive cures with an introduction of energy.

8. The housing according to claim 1 wherein said adhesive cures at temperatures of 200° to 85° C.

9. The housing according to claim 1 wherein said adhesive is an adhesive which cures upon irradiation using electromagnetic radiation.

10. The housing according to claim 9 wherein said plastic of said terminal housing has a transparency which is sufficiently high in wavelength range required to cure said adhesive to allow said adhesive to cure at a given irradiation intensity in at most four times of a duration specified for this irradiation intensity.

11. The housing according to claim 10 wherein said cure of said adhesive is activated by energy action and then proceeds independently.

12. The housing according to claim 1 further comprising a spacer in a size from 0.1 mm to 0.5 mm that is added to said adhesive.

13. The housing according to claim 1 wherein said terminal housing comprises two cavities on a side facing toward said hollow housing wherein said two cavities are configured to receive anchors attached to said hollow housing which together with said cavities cause precise positioning of said terminal housing in relation to said hollow housing before and when said terminal housing is coupled with said hollow housing.

14. The housing according to claim 1 wherein said electrical terminal is formed by at least one plug socket and an electrical contact situated in said plug socket wherein said plug socket is configured to receive a terminal plug of said electrode line.
